(19) United States
(12) Patent Application Publication
(10) Pub. No.: US 2007/0277128 A1
(43) Pub. Date: Nov. 29, 2007

(54) SYSTEM AND METHOD FOR SENSING SHAPE OF CHIP

(75) Inventors: Dong-Chul HAN, Chungcheongnam-do (KR); Jung-Hwan WOO, Chungcheongnam-do (KR); Youn-Sung KO, Chungcheongnam-do (KR)

Correspondence Address: MARGER JOHNSON & MCCOLLOM, P.C., 210 SW MORRISON STREET, SUITE 400, PORTLAND, OR, 97204, US

(73) Assignee: SAMSUNG ELECTRONICS CO., LTD., Gyeonggi-do (KR)

(21) Appl. No.: 11/752,183

(22) Filed: May 22, 2007

(30) Foreign Application Priority Data
May 29, 2006 (KR) 2006-0048307

(51) Int. Cl. G06F 17/50

(52) U.S. Cl. 716/1

(57) ABSTRACT

In one embodiment of a system for sensing the shape of a chip, a support plate is provided that preferably includes at least one chip mounted thereon. A lower lighting unit is preferably disposed below the support plate to emit light through the support plate and around or between the chip(s) toward an optical sensing unit, with a portion of the light emitted being blocked by the opaque chip(s). The optical sensing unit preferably senses the light that passes through the support plate and around or between the chip(s), but not the light that is blocked by the chip(s). In this manner, the shape of the chip can be more accurately determined, even when it is deformed within an acceptable range. A method for using a system constructed according to the principles of the present invention is also provided.

### CROSS-REFERENCE TO RELATED PATENT APPLICATION

This application claims the benefit of Korean Patent Application No. 10-2006-0048307, filed on May 29, 2006, in the Korean Intellectual Property Office, the disclosure of which is incorporated herein in its entirety by reference.

### BACKGROUND OF THE INVENTION

1. Field of the Invention

The present invention relates generally to a system and method for manufacturing a semiconductor chip (hereinafter, “chip”). And more particularly, to a system and method of using light to sense a shape of a chip.

2. Description of the Related Art

There are many types and shapes of semiconductor chips. During their manufacture, these chips are handled in a variety of processes, during which it may be important to accurately sense a shape of the chips. Although a variety of sensing methods could be used, one common method is to use reflected light to determine the chip shape. More particularly, in a process that includes picking up (or handling) a chip, its shape can be sensed using reflected light to assist in picking up the chip.

FIG. 1 is a cross-sectional view of a conventional system for sensing a shape of a chip using light. During operation, the system includes a chip 22 arranged on a support plate 20. Referring to FIG. 1, the support plate 20 on which the chip 22 is arranged is disposed on a support 10 (e.g., a plunger). An upper lighting unit 40 is configured to emit light onto a top surface of the chip 22 The upper lighting unit 40 may be installed directly above the chip 22 or it may be displaced towards a side of the chip 22. In either case, the light 30 emitted from the upper lighting unit 40 is reflected by the chip 22 and the support plate 20 and sensed by an optical sensing unit 50 (e.g., a camera).

Information regarding the expected shape of the chip 22 may be stored in a memory for reference.. The specific shape sensed by the optical sensing unit 50 from the light reflected from the chip 22 is then compared to the stored reference information to determine if the shape is within allowable tolerances. If it is, then the current process may continue. If it is outside the allowable tolerances, then one or more extra processes may need to be performed to further determine the shape of the chip 22. Such added processes may unfortunately require human interaction or other extra attention. Needless to say, the failure to adequately determine a shape of the chip 22 during an initial shape sensing process can significantly impair manufacturing and handling productivity.

In the conventional method, a color and brightness of the external lighting, an unevenness of the top surface of the chip 22, and other factors all affect the ability to accurately sense the shape of the chip 22. In addition, if the chip 22 is thin and easily deformed or warped, the light reflected from the surface of the chip 22 may be scattered, thereby preventing the shape of the chip from being accurately sensed. For example, as shown in the photographs contained in FIGS. 2A and 2B, a boundary portion 24 between the chips may not be clear (see FIG. 2A), or an excessive amount of light may be reflected from a portion of the surface of the chip 22 (see FIG. 2B). In either case, it might be difficult to accurately sense the shape of the chip 22.

### SUMMARY OF THE INVENTION

According to principles of the present invention, a system is preferably provided that can more accurately sense a shape of a chip. A more accurate method of sensing a shape of a chip using the system is also provided.

According to one aspect of the present invention, a system for sensing a shape of a chip includes a support plate on which one or more separated chips are arranged. A lower lighting unit is preferably disposed below the support plate, with the lower lighting unit configured to emit light through the support plate between the chips. An optical sensing unit is also preferably provided to sense the light that is passed through the support plate.

The lower lighting unit may include one or more light sources for emitting light and may further include a waveguide layer for guiding the light emitted from the light source(s). The waveguide layer may be formed of a transparent or semitransparent material and the light source(s) may be built in the waveguide layer.

According to another aspect of the present invention, there a system for sensing a shape of a chip can include a polymer film on which one or more separated chips are mounted. A lower lighting unit can be disposed below the polymer film, with the lower lighting unit configured to emit light though the polymer film between the chips. An optical sensing unit can also be provided to sense the light passed through the polymer film.

According to a yet another aspect of the present invention, a method of sensing a shape of a chip can include preparing a support plate on which one or more separated chips are arranged. The support plate can then be disposed on a lower lighting unit which emits light through the support plate between and around the separated chips. The light that passes through the support plate between and around the chips can then be sensed using an optical sensing unit. A shape of the chips can then be identified as defined by the light sensed by the optical sensing unit.

### BRIEF DESCRIPTION OF THE DRAWINGS

The above and other features and advantages of the present invention will become more apparent through the following detailed description of exemplary embodiments thereof, made with reference to the attached drawings, in which:

FIG. 1 is a schematic cross-sectional view of a conventional system for using light to sense a shape of a chip;

FIGS. 2A and 2B are photographs showing chips sensed by the conventional system of FIG. 1;

FIG. 3 is a schematic cross-sectional view of a system for using light to sense a shape of a chip according to an exemplary embodiment of the present invention;

FIG. 4 is a photograph showing a support plate having a plurality of separated chips arranged thereon, as sensed by an optical sensing unit of the system of FIG. 3;

FIGS. 5A and 5B are schematic block diagrams illustrating various steps in two alternative embodiments of a method of controlling power supplied to a light source of a chip shape sensing system, according to another aspect of the present invention;

FIG. 6 is a schematic cross-sectional view of one embodiment of a lower lighting unit according to yet another aspect of the present invention;

FIG. 7 is a photograph showing a top view of the lower lighting unit embodiment of FIG. 6:

FIG. 8 is a schematic cross-sectional view of a lower lighting unit according to another embodiment; and

FIG. 9 is a schematic cross-sectional view of a lower lighting unit according to a still further embodiment.

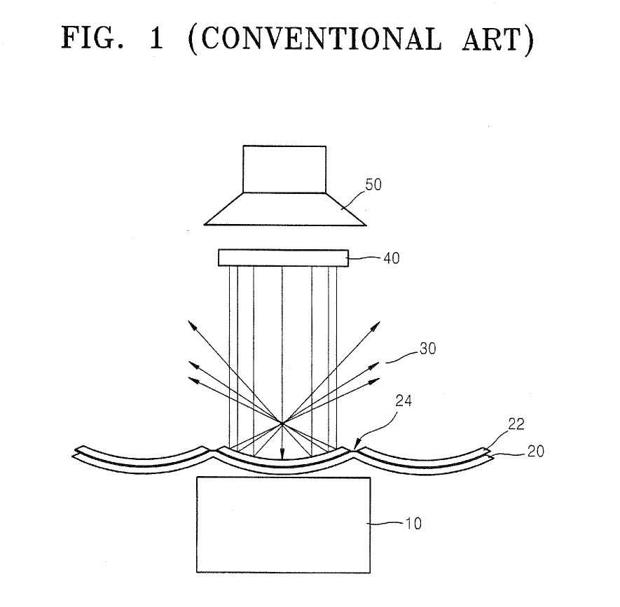

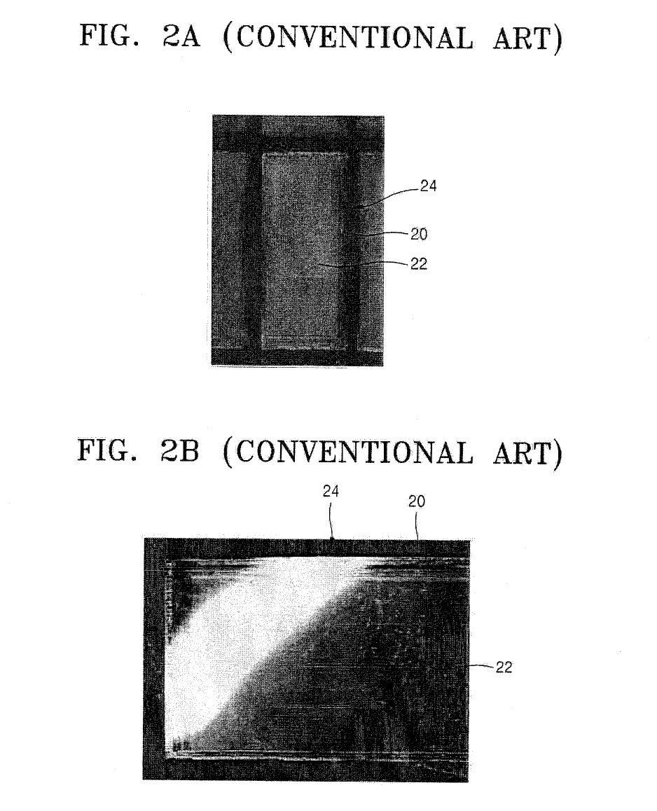

### DETAILED DESCRIPTION OF THE INVENTION

Various preferred embodiments of the present invention will now be described in detail, examples of which are illustrated in the accompanying drawings. The invention may, of course, be embodied in many different forms and should not be construed as being limited to the various preferred embodiments set forth herein. Rather, these exemplary embodiments are provided only by way of example so that this disclosure will be thorough and complete, and will convey the inventive concepts to those skilled in the art. Like reference numerals refer to like elements throughout the drawings.

According to various principles of the present invention, a system for sensing a shape of a chip may use a lower lighting unit. The chips whose shapes are sensed using the embodiments described herein are not limited to those used for processing an electrical signal but may include any number of a variety of chip types. For example, the chip may be provided with a pattern for processing electrical signals, such as a semiconductor memory device. Alternatively, however, the chip may lack such a pattern. The specific details of the chip are therefore relevant only with regards to the sensing of its shape..

A process for picking up a chip during a semiconductor manufacturing process will be discussed by way of example to describe the various embodiments of the present invention. However, the system is not limited to the picking-up process and may be applied to any process in which a shape of the chip is to be identified. In the picking-up process, a picker picks up the chip and transfers it to another device, such as a sorter. Before picking up the chip, a process for sensing a shape of the chip may be desirable.

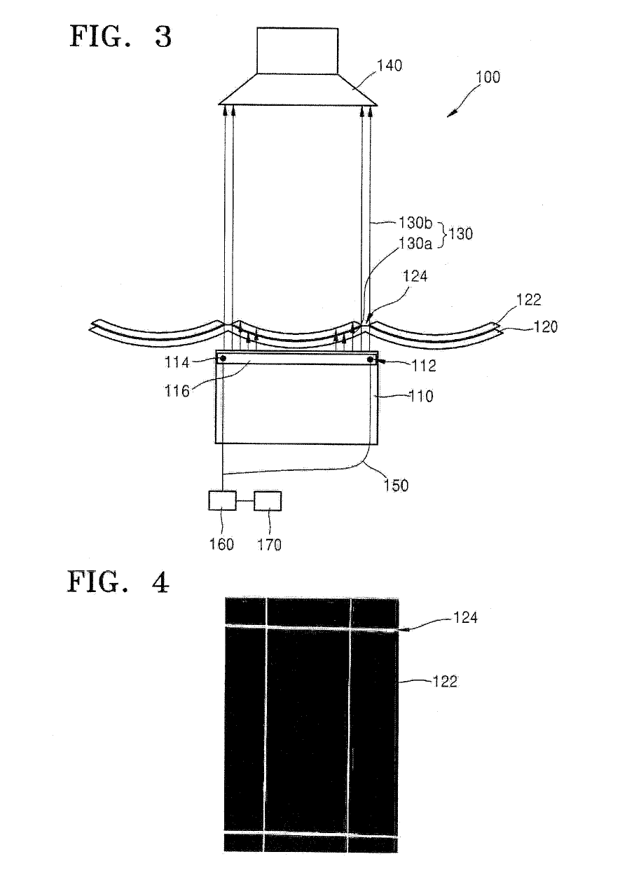

FIG. 3 is a schematic cross-sectional view of a system 100 for sensing a shape of a chip 122 according to an exemplary embodiment of the present invention. In operation, the system 100 includes a chip 122 mounted or attached on a support plate 120. When mounted on the support plate 120, the chip, or chips, may merely rest on the support plate 120 by gravity and need not be physically attached. The chip 122 may, however, be mounted or attached to the support plate 120 by mechanical or adhesive means, for example.

Referring to FIG. 3, the sensing system 100 preferably includes a support 110 having a lower lighting unit 112, a support plate 120 on which the chip 122 is arranged, and an optical sensing unit 140 for sensing light 130a passing through the support plate 120. The support plate 120 is disposed on a support 110 (e.g., a plunger). The chip may or may not be provided with a pattern for processing electrical signals.

The chip 122 may have a deformed shape within an allowable range. For example, the chips produced through a singulation process, where individual chips are cut and divided apart from their original wafer, may either be flat or somewhat bent. These variations in the shapes of the chips 122 may be considered when setting an allowable error range within which the shape of the chip is regarded as capable of being accurate sensed. The allowable error may vary in accordance with a process property, a shape of the chip, and the like.

The chip 122 may be mounted or attached, as discussed above, on the support plate 120 in a conventional method. The support plate 120 is preferably formed of a transparent or a semitransparent material so that light 130 can pass through the support plate 120. For purposes of this disclosure, the terms “transparent” and “semitransparent” mean that at least some portion of incident light is able to pass through the support plate 122. “Transparent” means that at least slightly more light is able to pass through as compared to “semitransparent.”The optical sensing unit 140 is preferably configured to sense light having an intensity equal to or greater than a predetermined threshold value. The predetermined threshold value may vary in accordance with the process, the shape of the chip 122, a type of the support plate 120, and other factors. The support plate 120 is preferably formed of a material that can transmit light 130 from the lower lighting unit 112 with an intensity equal to or higher than the threshold value. The support plate 120 may be constructed in a variety of forms, such as a film, a sheet, or other forms. The support plate 120 may, for example, be formed of a polymer film.

The lower lighting unit 112 preferably includes a light emission surface. A light source 114 may be used as the lower lighting unit 112 itself. Alternatively, the lower lighting unit 112 may include a waveguide layer 116 housing the light source 114. The light source 114 may, for instance, be selected from the group consisting of a light emitting diode (LED), a halogen lamp, a fluorescent lamp, an incandescent lamp, an organic LED, or other light sources. The number and arrangement of light sources 114 in the lower lighting unit 112 may vary as needed. To uniformly emit the light 130, however, the light sources 114 are preferably arranged spaced apart from each other by an equal interval, or facing each other along a circumference of the lower lighting unit 112.

The lower lighting unit 112 may be configured to sense one or more chips 122, and is not limited to any particular structure or shape. For example, the lower lighting unit 112 may comprise a flat plate form or may be formed by a plurality of light sources 114 separated and gathered in island-like groups. The lower lighting unit 112 may directly contact the support plate 120 or it may be spaced apart from the support plate 120 by a predetermined distance.

The waveguide layer 116 may also be formed of a transparent or a semitransparent material, for instance such as Teflon resin or acryl resin. The particular style of support 110 may be selected considering the handling purpose of the chip 122. For example, the support 110 may comprise a plunger, as will be described in detail later.

FIG. 4 is a photograph showing a plurality of chips 122 arranged on the support plate 120. Referring to FIGS. 3 and 4, the shapes of the chips 122 are preferably sensed by the optical sensing unit 140 using the system described above. The white areas 124 in FIG. 4 are created where light 130b is allowed to pass through the support plate 120 and define the boundaries of the chips 122. The dark areas 122 in FIG. 4 are formed as the light 130a is blocked by the chips 122 and thereby illustrate the location and shape of the chips 122.

A method of sensing the shape of the chip 122 will now be described according to another aspect of the present invention. Again referring to FIGS. 3 and 4, one or more chips 122 are arranged on a support plate 120 located between a lower lighting unit 112 and an optical sensing unit 140. Light is then emitted from the lower lighting unit 112 in the direction of the optical sensing unit 140. A portion 130a (the blocked portion) of the light 130 emitted from the lower lighting unit 112 is blocked by the chip 122, while another portion 130b (the transmitted portion) of the light 130 passes through the support plate 120 between the chips 122.

As illustrated in FIG. 4, at the optical sensing unit 140, the area where the portion 130a of the light 130 is blocked is represented as a dark or black color (at 122), while the transmitted light 130b is represented as a bright or white color (at 124). The dark areas in the image shown in FIG. 4 therefore correspond to the location and shape of the chips 122, while the bright areas correspond to a boundary portion 124 between the chips 122. Accordingly, the sensing system 100 of this exemplary embodiment of the present invention may thereby determine the shape of the chip 122 using the various portions of the image received by the optical sensing unit 140. This image may, for instance, be a photograph, a software bitmap image, or other sensing medium, and may be interpreted using binary image processing or other image processing software or hardware, for example.

Since the light 130 has known directionality, it is suitable for transferring an image corresponding to the boundary portion 124 of the support plate 120 to the optical sensing unit 140. Accordingly, using the sensing system 100 of this exemplary embodiment, the boundary portion 124 may be sensed by the optical sensing unit 140, and the shape of the chip 122 can thereby be accurately determined. In this manner, the problems experienced by the prior art, including inaccurate shape determination due in large part to unclear boundary portions 124, can be solved. It should be noted that although an image of the chip 122 having a rectangular shape is shown in FIG. 4, other chip shapes can also be accurately sensed using the above-described system and method.

While the light 130 emitted from the lower lighting unit 112 may be slightly refracted or diffracted while passing through or exiting the support plate 120, as long as a size of the image sensed by the optical sensing unit 140 is within an allowable range (when compared with an actual size of the chip 122), the identification of the shape of the chip 122 is possible. In addition, even when the chip 122 is deformed or bent, the shape of the chip 122 can still be sensed if the light 130 emitted from the lower lighting unit 112 is within the allowable range.

It is sometimes desirable to determine a location of a center of the chip 122. This can also be readily accomplished using the principles of the present invention. Referring still to FIG. 4, when the chip 122 is rectangular, the center of the chip 122 is located in a position corresponding to a midpoint of the sides of the chip 122. The center can therefore easily be determined using the sensed shape of the chip 122. That is, since the lengths of the sides can be accurately determined using the principles of the present invention, so can the location of the center of the chip 122. Of course, these principles also permit the determination of a location of the center, or other points or geometries of the chip 122, regardless of the shape of the chip 122.

Other features and aspects of the present invention will now be further described. Referring again to FIG. 3, an electric wire 150 may be disposed in the support 110 to supply electric power to the lower lighting unit 112. The electric wire 150 may be connected to a control unit 170 through a connection terminal 160. The power applied to the lower lighting unit 112 may be controlled using the control unit 170.

In an alternative embodiment, an upper lighting unit (not shown) may also be provide to emit light toward the chip 122 from above. The upper lighting unit may perform a different function than that of the lower lighting unit 112. For example, the upper lighting unit may be used to generally observe a wafer having a plurality of chips 122. The upper lighting unit may also be used to measure or inspect chips 122 having a relatively small deformation, or to detect chip deformations.

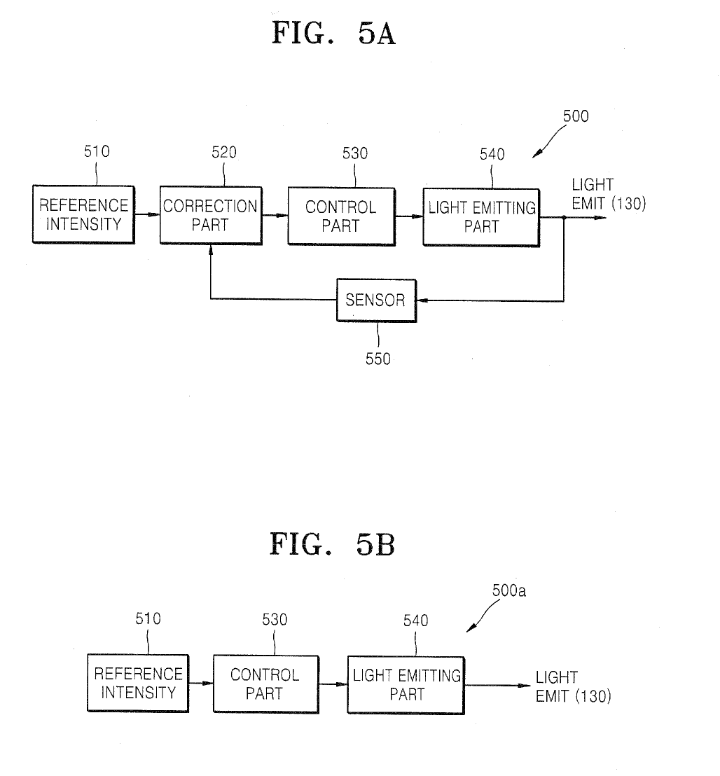

FIG. 5A is a schematic block diagram illustrating one embodiment of a control system 500 for controlling the intensity of the light 130 supplied to the chip shape sensing system 100, according to another aspect of the present invention. Referring now to FIG. 5A, a desired reference intensity 510 may be determined and an actual intensity of the light 130 emitted by a light emitting part 540 may be controlled by controlling the voltage or current source of the light 130 using a control part 530. The intensity of the emitted light 130 may then be measured by a sensor 550, such as a light intensity measuring sensor or a current sensor. An error resulting from a discrepancy between the light measurement and the desired intensity can then be corrected using a correction part 520 (e.g., a circuit). This type of control method may be referred to as a “closed circuit feed-back control.”

FIG. 5B illustrates an alternative embodiment of a light intensity control system 500a. Referring to FIG. 5B, the control system 500a of this embodiment includes a control part (unit) 530 that controls the intensity of the light 130 from the light emitting part 540 by directly controlling a source voltage or current based on the reference intensity 510. This control method may be referred to as an “open circuit control.” Other control methods may also be used to accomplish the principles of the present invention.

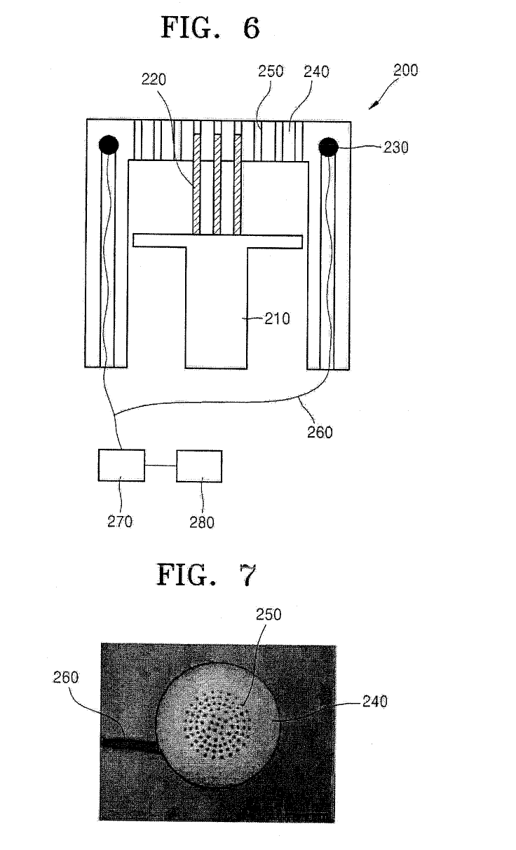

FIG. 6 is a schematic cross-sectional view of a lower lighting unit 200 according to an embodiment of yet another aspect of the present invention. FIG. 7 is a photograph showing a top view of the lower lighting unit 200. Referring to FIGS. 6 and 7, the lower lighting unit 200 can include a support 240 having light sources 230 built into the support 240. The light sources 230 may, for instance, be selected from the group comprising an LED, a halogen lamp, a fluorescent lamp, an incandescent lamp, an organic LED, and other light sources. The number and arrangement of the light sources 230 may vary as desired for a particular application.

The support 240 may be formed of a transparent or a semitransparent material, for example, such as Teflon resin or acryl resin, that permits light to pass through it. The support 240 may be arranged at an upper portion of the lower lighting unit 200, with a plurality of holes 250 formed therethrough to receive pins 220 of a plunger 210. The pins 220 of the plunger 210 may slide through the holes 250 to push the chip 122 upward. Electric wires 260 may be inserted in a side portion of the support 240. The electric wires 260 may be connected by a connection terminal 270 to a control unit 280. Electric power supplied to the light sources 230 may thereby be controlled using the control unit 280.

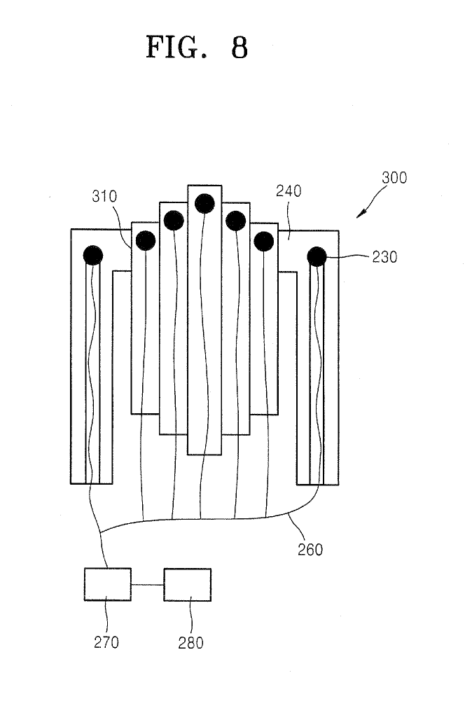

FIG. 8 is a schematic cross-sectional view of a lower lighting unit 300 according to another embodiment of this aspect of the present invention. Referring to FIG. 8, the lower lighting unit 300 can also include a support 240 having light sources 230 built into the support 240. The light sources 230 may again be selected from the group comprising an LED, a halogen lamp, a fluorescent lamp, an incandescent lamp, an organic LED, and other light sources. And the number and arrangement of the light sources 230 may be varied as desired.

The support 240 may be formed of a transparent or a semitransparent material that permits the light from the light sources 230 to pass through it. The support 240 is again provided at an upper portion of the lower lighting unit 200. In this case, the support 240 includes an opening through which a plunger 310 can move to push the chip 122 upward. Electric wires 260 may be inserted in a side portion of the support 240 and connected to a control unit 280 through a connection terminal 270. The plunger 310 in this embodiment is preferably formed in a pyramid shape to push the chip upward. The plunger 310 itself may be formed of a transparent or a semitransparent material, for instance, such as Teflon resin or acryl resin, so that the light can pass through it.

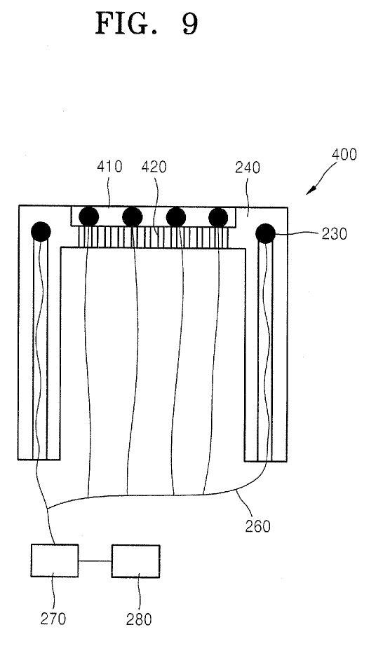

FIG. 9 is a schematic cross-sectional view of a lower lighting unit 400 according to yet another embodiment of this aspect of the present invention. Referring to FIG. 9, the lower lighting unit 400 also includes a support 240 having light sources 230 built into the support 240. The light sources 230 can be similar to those described above with the number and arrangement of the light sources 230 varied as desired for the particular application. And the support 240 may again be formed of a transparent or a semitransparent material.

In this embodiment, however, the support 240 can include a vacuum shutter 410 arranged at an upper portion thereof to hold the support plate 120 (see FIG. 3) using a vacuum force. The vacuum force may be applied through a plurality of vacuum holes 420 formed under the vacuum shutter 410. Electric wires 260 may again be inserted in a side portion of the support 240 and connected to a control unit 280 by a connection terminal 270.

The vacuum shutter 410 is preferably configured to open and close the vacuum holes 420 to supply and cut off the vacuum force to the support plate 120. The vacuum shutter 410 may open or close the vacuum holes 420, for example, by sliding across the support 240. The chip 122 and the support plate 120 can thereby be selectively held or released from the support 240 by controlling the vacuum shutter 410. The vacuum shutter 410 may be formed of a transparent or a semitransparent material such as Teflon resin or acryl resin so that the light can pass through it.

As can be seen from the above description of various preferred embodiments, according to the principles of the present invention, a system can accurately sense the shape of a chip by utilizing a lower lighting unit emitting light towards the chip from below. Using a system and method according to these principles, the shape of the chip can be reliably sensed even when the chip is thin and deformed or warped. In particular, the use of a binary image, for instance, can aid in the accurate sensing of chip shape.

While the present invention has been particularly shown and described with reference to various exemplary embodiments thereof, it will be understood by those of ordinary skill in the art that changes in the form and details of those embodiments may be made without departing from the spirit and scope of the present invention as defined by the following claims.

What is claimed is:

1. A system for sensing a shape of a semiconductor chip, the system comprising:
a support plate on which one or more chips can be mounted;
an optical sensing unit disposed above the support plate; and
a lower lighting unit disposed below the support plate, the lower lighting unit comprising a light source configured to emit light through the support plate towards the optical sensing unit

2. The system of claim 1, wherein one or more separated chips are arranged on the support plate.

3. The system of claim 2, wherein at least a portion of the light passing through the support plate is blocked by the one or more chips, and wherein at least another portion of the light passing through the support plate reaches the optical sensing unit.

4. The system of claim 3, wherein the portion of the light reaching the optical sensing unit corresponds to a shape of the one or more chips.

5. The system of claim 1, wherein the support plate is formed of a polymer film.

6. The system of claim 1, wherein the lower lighting unit includes more than one light source.

7. The system of claim 1, wherein the lower lighting unit includes a waveguide layer for guiding the light emitted from the light source, and wherein the light source is disposed in the waveguide layer.

8. The system of claim 7, wherein the waveguide layer is formed of a transparent or semitransparent material.

9. The system of claim 8, wherein the waveguide layer is formed of Teflon resin or acryl resin.

10. The system of claim 7, wherein the light source comprises a plurality of light sources arranged in the waveguide layer, said plurality of light sources spaced apart from each other by equal distances.

11. The system of claim 10, wherein the light sources are arranged opposite each other along a circumference of the waveguide layer.

12. The system of claim 1, wherein the lower lighting unit is mounted on a support.

13. The system of claim 12, wherein the support is formed of a transparent or semitransparent material.

14. The system of claim 13, wherein the support is formed of Teflon resin or acryl resin.

15. The system of claim 12, wherein the support comprises a plunger for removing a chip from the support plate.

16. The system of claim 1, wherein the lower lighting unit further includes a control unit for controlling an intensity of the light emitted from the light source.

17. The system of claim 1, further comprising an upper lighting unit for emitting light toward the support plate from above the support plate.

18. A system for sensing a shape of a chip, comprising:
a polymer film on which one or more separated chips are mounted;
a lower lighting unit disposed below the polymer film, the lower lighting unit comprising a light source configured to emit light through the polymer film and around or between the one or more separated chips; and
an optical sensing unit for sensing the light passed through the polymer film and around or between the one or more separated chips.

19. The system of claim 18, wherein one or more of the chips are deformed within an allowable range and wherein the system can adequately detect the shape of the one or more deformed chips.

20. The system of claim 18, wherein the lower lighting unit includes only one light source.

21. The system of claim 18, wherein the lower lighting unit includes a waveguide layer for guiding the light emitted from the light source, the light source being arranged inside the waveguide layer.

22. The system of claim 21, wherein the waveguide layer is formed of a transparent or semitransparent material.

23. The system of claim 22, wherein the waveguide layer is formed of Teflon resin or acryl resin.

24. The system of claim 18, wherein the lower lighting unit further includes a plunger for removing the one or more chips from the polymer film.

25. The system of claim 18, further comprising an upper lighting unit configured to emit light toward the one or more chips from above the one or more chips.

26. A method of sensing a shape of a chip, comprising:
arranging one or more separated chips on a support plate;
disposing the support plate over a lower lighting unit;
emitting light from the lower lighting unit so that the light is passed through the support plate and blocked by the one or more separated chips but permitted to pass around or between the one or more chips;
sensing the light passed around or between the one or more chips using an optical sensing unit; and
determining the shape of the chip using the light sensed by the optical sensing unit.

27. The method of claim 26, wherein the optical sensing unit senses light having an intensity equal to or greater than a predetermined threshold value.

28. The method of claim 26, wherein the light passed through the support plate and around or between the one or more chips has an intensity equal to or greater than a threshold value.

29. The method of claim 26, further comprising determining a desired location on the surface of at least one of the one or more chips using shape information identified by the optical sensing unit.

30. The method of claim 29, wherein the shape information includes lengths of sides of one or more of the chips, and wherein determining a desired location on the surface of one of the chips comprises using the lengths of sides of that chip to determine a center location of that chip.
